(19) United States
(12) Patent Application Publication
(10) Pub. No.: US 2024/0184283 A1
(43) Pub. Date: Jun. 6, 2024

(54) Time-Series Segmentation and Anomaly Detection

(71) Applicant: PDF Solutions, Inc., Santa Clara, CA (US)

(72) Inventors: Tomonori Honda, Santa Clara, CA (US); Edward Zhou, Belmont, CA (US); Jeffrey D. David, Carmel, CA (US)

(73) Assignee: PDF Solutions, Inc., Santa Clara, CA (US)

(21) Appl. No.: 18/527,156

(22) Filed: Dec. 1, 2023

Related U.S. Application Data
(60) Provisional application No. 63/429,835, filed on Dec. 2, 2022.

(51) Int. Cl. G05B 23/02

(52) U.S. Cl. CPC G05B 23/0283; G05B 23/0254

(57) ABSTRACT

Detection of data anomalies resulting from maintenance activities on semiconductor processing equipment. Time-series representation of the key indicators for equipment performance is cleaned then segmented according to sharp breaks in the data. The cleaned and segmented data is modeled, for example, by determining a linear fit for each segment. The slope and intercept of each modeled segment linear fit are compared and evaluated to identify anomalies in the data.

### CROSS-REFERENCE

This application claims priority from U.S. Provisional Patent Application No. 63/429,835, filed Dec. 2, 2022, and entitled Method for Identifying Time Series Segments and Detect Anomalies using Time Series for Manufacturing Indicator and/or Sensor Measurements, the entire disclosure of which is incorporated herein by reference.

### TECHNICAL FIELD

This disclosure relates generally to semiconductor manufacturing processes, and more particularly, to systems and methods for identifying data anomalies that result from changes in processing equipment.

### BACKGROUND

The manufacture of semiconductor devices is a complex undertaking involving sophisticated high-tech equipment, a high degree of factory automation, and ultra-clean manufacturing facilities thereby requiring significant capital investment and ongoing maintenance expense. A typical device requires hundreds of steps using multiple pieces of equipment for a process recipe carried out over many weeks.

The operation and performance of each piece of equipment is monitored in numerous ways and information collected from a variety of sources, including mechanical and electrical/electronic sources such as temperature sensors, pressure sensors, torque sensors, accelerometers, etc. The source information can then be evaluated, typically using statistical methods to define key indicators that are deemed relevant to yield, quality, or any parameter of interest. The data from these sources under normal operating conditions is expected to be at or close to a target value and within an acceptable range, as defined for the particular process recipe. Thresholds may be set at minimum and/or maximum values, for example, and excursions that exceed a threshold (or fall out of range) can be flagged for analysis and action. However, statistical methods are not always effective to reveal anomalies, and automatic methods for determining indicator thresholds are known, such as those disclosed in U.S. Pat. No. 11,609,812 entitled Anomalous Equipment Trace Detection and Classification, incorporated herein by reference.

Regular evaluation of the equipment data is important for determining appropriate timing for scheduling preventive maintenance (“PM”) activities to minimize process interruptions due to equipment problems or failures. However, performance of PM activities on a piece of equipment usually causes a sudden (but expected) change in data values or trends, as an item is repaired, replaced, recalibrated, or otherwise modified. The change in data trend(s), combined with the inherent and inconsistent existence of noise in the data, often makes it difficult to quickly identify anomalous behavior that may have resulted from the PM activities, and to act quickly to correct any problems causing the anomalous behavior. For example, a gas valve may have been replaced during PM but the valve was faulty or it was not installed correctly thereby leading to off-quality production. It would be desirable to improve detection methods to be able to very quickly identify the anomalous data behavior in order to take corrective action and to avoid or minimize a significant impact on product yield and quality, and further, to be able to perform predictive maintenance based on the equipment data before equipment issues become problematic.

### SUMMARY

Improved methods are described for detecting data anomalies that may have occurred as a result of maintenance activities on semiconductor processing equipment. Sensor data obtained from semiconductor processing equipment is represented by statistical indicators, or by features determined from machine learning or from envelope functions, in a time-series dataset. The dataset is first cleaned to remove data outliers. The cleaned dataset is then segmented according to breaks in the data, e.g., times when a step change in the slope or intercept value is detected. The cleaned and segmented dataset is then modeled statistically, for example, by determining a linear fit for each segment. The slope and intercept of each segment linear fit are compared and evaluated to identify anomalies in the dataset.

### BRIEF DESCRIPTION OF THE DRAWINGS

FIG. 1 is a flow chart illustrating a method for detection of anomalies related to equipment maintenance activities.

FIG. 2 is a graph of an example statistical indicator plotted over time.

FIG. 3 is a graph of an example statistical indicator for different pieces of the same type equipment plotted over time.

FIG. 4 is a flow chart illustrating a data cleaning method.

FIG. 5 is a graphical example of datasets unsuitable for improved processing.

FIG. 6 is a graphical example of a dataset suitable for improved processing.

FIG. 7 is the graphical example of FIG. 6 after applying a segmentation algorithm.

FIG. 8 is a flow chart illustrating a method for determining outliers in a dataset.

FIG. 9 is the graphical example of FIG. 6 after removing outliers.

FIG. 10 is the graphical example of FIG. 9 after bootstrapping.

FIG. 11 is a graphical example of another dataset of uncleaned sensor data.

FIG. 12 is the graphical example of FIG. 11 after removing outliers.

FIG. 13 is the graphical example of FIG. 12 after bootstrapping.

FIG. 14 is the graphical example of FIG. 9 after applying a segmentation algorithm.

FIG. 15 is the graphical example of FIG. 9 after applying a rolling window algorithm.

FIG. 16 is the graphical example of FIG. 13 after applying a segmentation algorithm.

FIG. 17 is the graphical example of FIG. 16 after applying a rolling window algorithm.

FIG. 18 is the graphical example of FIG. 10 after applying a linear fit model.

FIG. 19 is the graphical example of FIG. 16 after applying a linear fit model.

### DETAILED DESCRIPTION

All semiconductor manufacturing operations include some type of automated system for Fault Detection and Classification (or Control)(“FDC”). FDC systems typically rely upon statistical analysis of source data to provide “indicators” or “FDC indicators” that are considered significant with regard to the quality and/or yield for individual process steps and for the overall process. However, as noted above, inherent noise in the data combined with changes in data trends caused by preventive maintenance often makes it difficult to quickly and accurately analyze the data and take prompt corrective action when necessary.

In this disclosure, we describe a method for improved and more timely detection of anomalies from analysis of the FDC indicators related to the operation of the semiconductor manufacturing and processing equipment. While various embodiments are described, the disclosure is not intended to be limited to these embodiments.

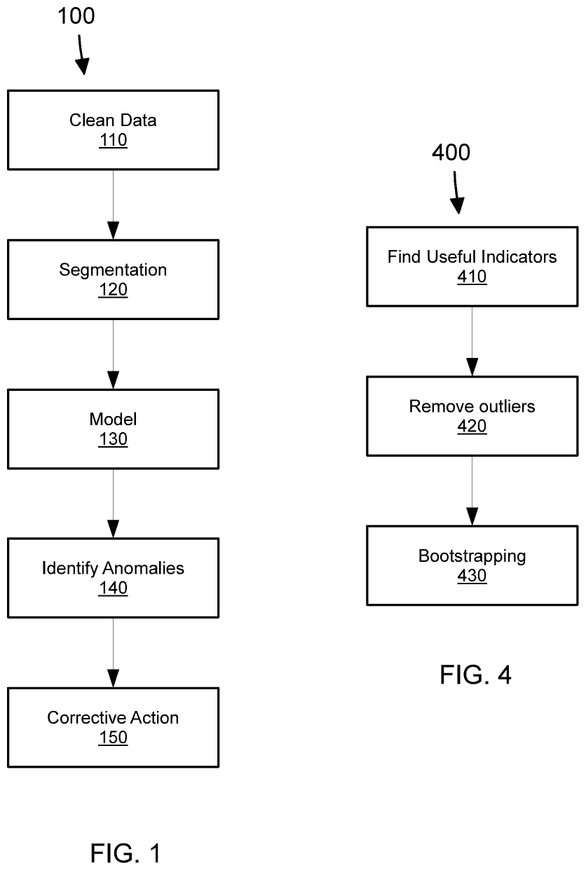

FIG. 1 illustrates a method 100 for improved detection. In step 110, statistical data representing the time-series source data is “cleaned” to minimize noise in the data. Following the cleaning step 110, the cleaned data is run through a segmentation algorithm in step 120. In step 130, the cleaned and segmented data is statistically modeled. In step 140, anomalies in the data are identified based on analysis of the statistical model. Finally, in step 150, corrective action is taken as necessary, for example, the equipment responsible for the data excursion is repaired, replaced or recalibrated. Each of these method steps is further described in further below.

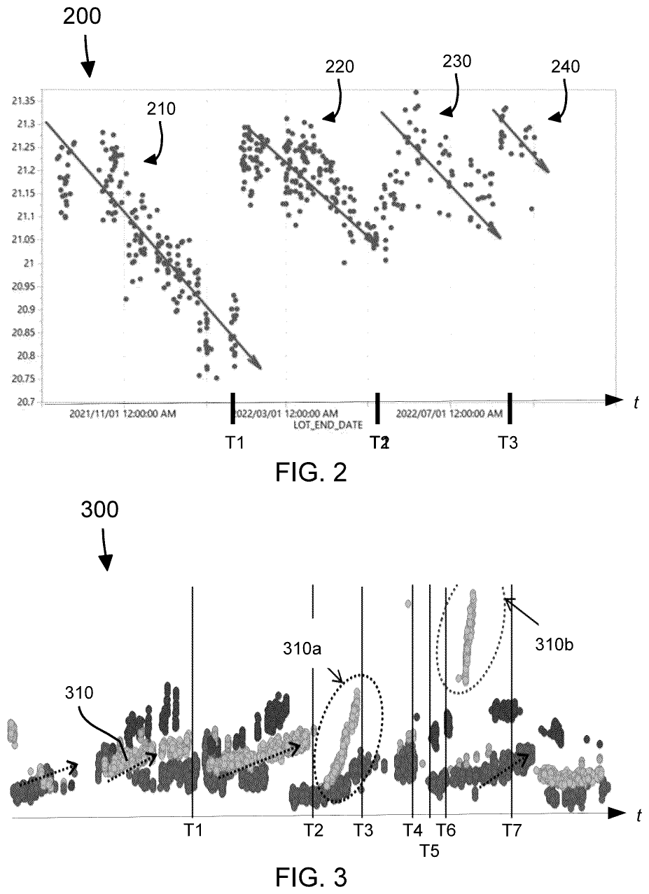

The nature of the problem is illustrated in FIG. 2, where graph 200 shows plots of an FDC statistical indicator computed from time-series trace data obtained from a specific piece of equipment. It can be seen from the plot that the data has a lot of noise; but also, three distinct breaks in the data, namely sudden increases in the y-axis values at time T1, T2 and T3, that divide the data into four groupings 210, 220, 230, 240. In this example, the step change in the y-axis values is attributable to a preventive maintenance (“PM”) activity on the specific equipment represented by the data. Further, the step change in the y-axis values is consistent and likely considered normal, with each data grouping appearing to have the same or similar trends, as indicated by trend arrows superimposed onto the data.

Unfortunately, the noise and step changes in the data can limit how useful the FDC indicators will be, for example, in the quest to improve overall equipment effectiveness as well as optimize the specific PM activity. For example, after a PM activity, a shift in the FDC indicator is expected, but it important to know if the shift is typical or anomalous—and if anomalous, to act quickly to identify and to correct the problem.

FIG. 3 is another graphical example that clearly illustrates the need for timely detection. Graph 300 plots a key FDC indicator for several different pieces of the same type of equipment (shown as different shades of grey), for example, a sensor that indicates throttle position for a gas valve. Of particular interest is equipment indicator 310 (shown as lighter grey). Vertical lines T1-T7 on the plot indicate points in time when a PM activity was performed on the equipment represented by indicator 310. It can be seen from the data plot that after the PM activity at time T2, FDC indicator 310a shows a very sharp increase in its slope. After PM activity at time T6, indicator 310b now has a larger y-intercept and an even steeper slope. The steep slope represents a problem that results in yield loss. Setting upper and lower limits on indicator values is not an adequate measure for quickly detecting the first hint of a potential issue, since it can be seen after time T2 that indicator 310a is already indicating a likely problem by its steep slope presenting a radically different trend, but an out of limit detection does not occur until after time T6.

### Data Cleaning

As noted above, the objective of the cleaning step is to reduce noise in the data. FIG. 4 shows a process 400 for doing so. In step 410, useful indicators are identified in relation to the equipment of interest and make up the dataset of interest. Outliers are then removed from the dataset (or replaced in some embodiments) in step 420, and finally, a bootstrapping process is applied to reduce variations in the dataset in step 430. It should be noted that step of removing outliers is actually optional at this point, and may instead be incorporated into step 410 and preprocessed when the indicators are determined.

Identifying and selecting appropriate indicators for analysis is basic for effective FDC techniques. The appropriate relevant indicators may be discovered through known techniques such as feature engineering, or through automated methods using machine learning models such as those described in U.S. Pat. No. 11,609,812. In many instances, however, it is already known which indicators are useful for constructing an appropriate dataset for analyzing a given process and its equipment performance. The problem addressed here is that the presence of outliers as noise in the data can make it difficult to quickly detect and/or visualize trends from the data.

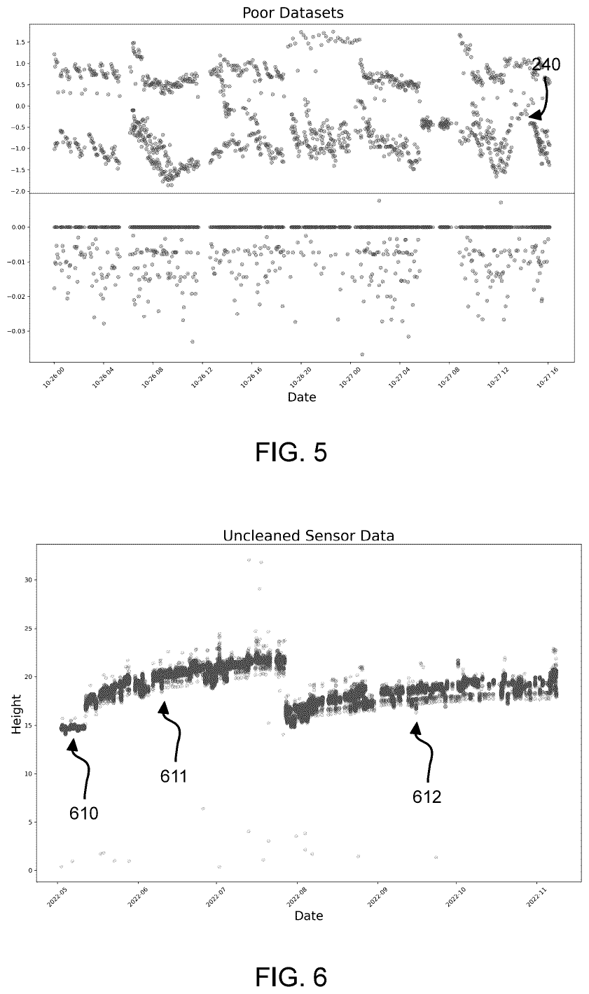

Some datasets are not well-suited to the techniques described herein. For example, FIG. 5 shows two sets of very scattered data plotted above the y=0 axis, and below the y=0 axis is a flat line with many outliers below the flat line. While some gaps are apparent throughout this data, there are no obvious trends or conclusions that can be drawn. Thus, the disclosed technique works well when there is an obvious trend over time for a particular indicator. The trend could be revealed due to the underlying physics as a constant value, a linear line, or a predefined curve such as an exponential function, a logarithmic function, etc. Further, poor equipment maintenance can change the shape of the trend line within the segments.

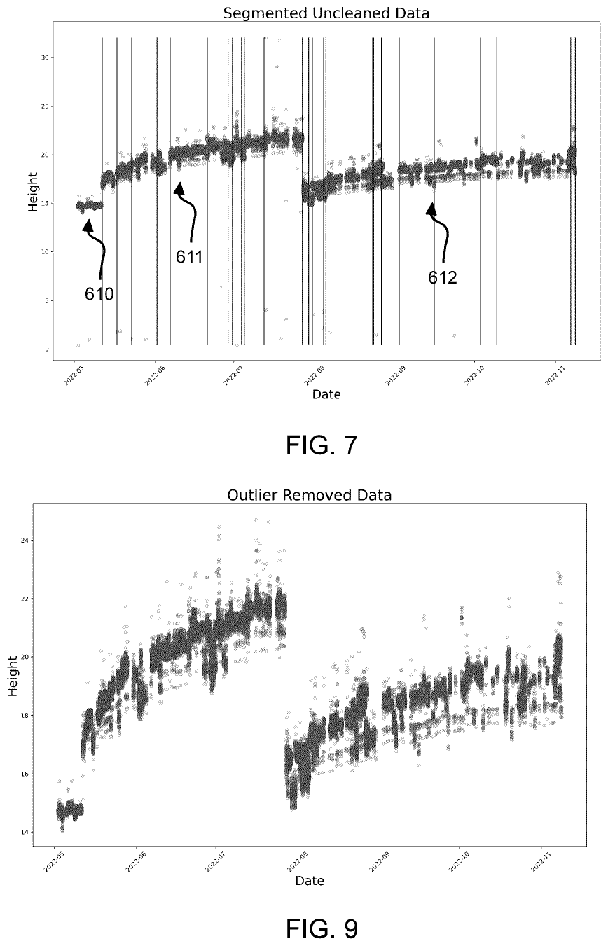

In contrast, FIG. 6 is a good candidate dataset for processing since this figure shows a clear trend, starting with a small line 610 and some outliers, then a slight upward curve 611 with some outliers, then a break in the y-axis value, then another slight upward curve 612 with some outliers. However, if a segmentation algorithm is applied at this point, as shown in FIG. 7, the results are not improved, that is, no real trend is apparent. Thus, in accord with the method described herein, the outliers (or singularity points) need to be removed first.

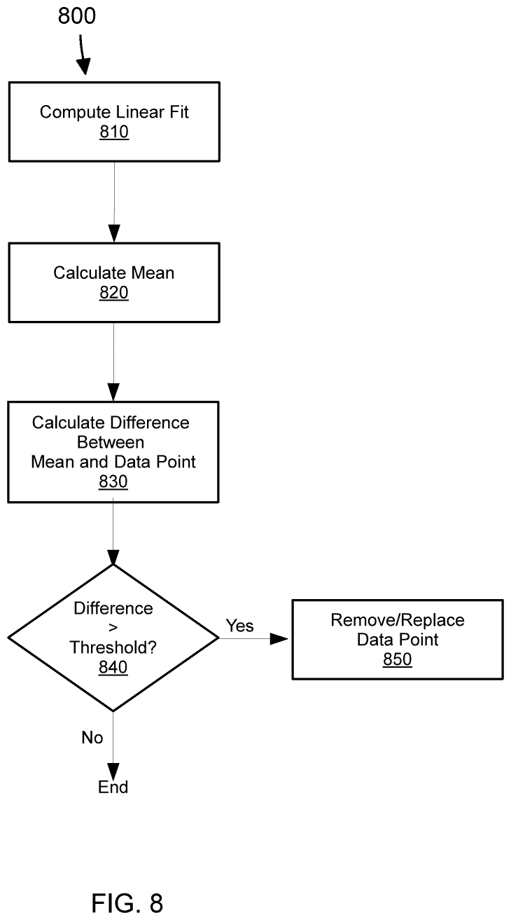

Thus, given a sample of the dataset for a given time range, the task is to find the outliers. In one example, a localized evaluation is performed around each data point, as illustrated by method 800 in FIG. 8. For each data point in a sample of the dataset, a statistical linear fit is computed around a set of neighboring data points (except for endpoints) in step 810. The mean value of the linear fit is calculated in step 820, and in step 830, the difference between the mean value of the linear fit and the actual value of the data point is calculated. If the difference between the two values exceeds a threshold in step 840, then the data point is either replaced in the dataset with the mean value or removed from the dataset altogether (step 850). A common threshold (upper and/or lower limit) may be set at three times the interquartile range (“IQR”), i.e., three times the spread of the middle half of the dataset distribution.

A simple conceptual description is to consider neighboring data points to the left and right of the subject data point; determine the mean of that defined neighborhood of points; evaluate the difference between the mean and the data point(s) of interest and make a decision about which value is off, the mean value or the data point.

Once the outliers are removed (or replaced), an optional bootstrapping operation is performed to reduce variation in the data thereby creating a more normal data distribution. Bootstrapping techniques are generally well-known statistical techniques for approximating a distribution function by sampling from the actual dataset distribution.

There are a number of other common methods that can be used to identify outliers, such as looking at an aggregate statistic over a rolling window. For instance, data points may be determined to be outliers by comparing the data points to the median of a selected time period, and data points that exceed a threshold, such as 1.5 times IQR or 3 times the standard deviation, are deemed outliers. This operation can be performed manually or by using known implementations such as the Hampel filter. See https://pypi.org/project/hampel/.

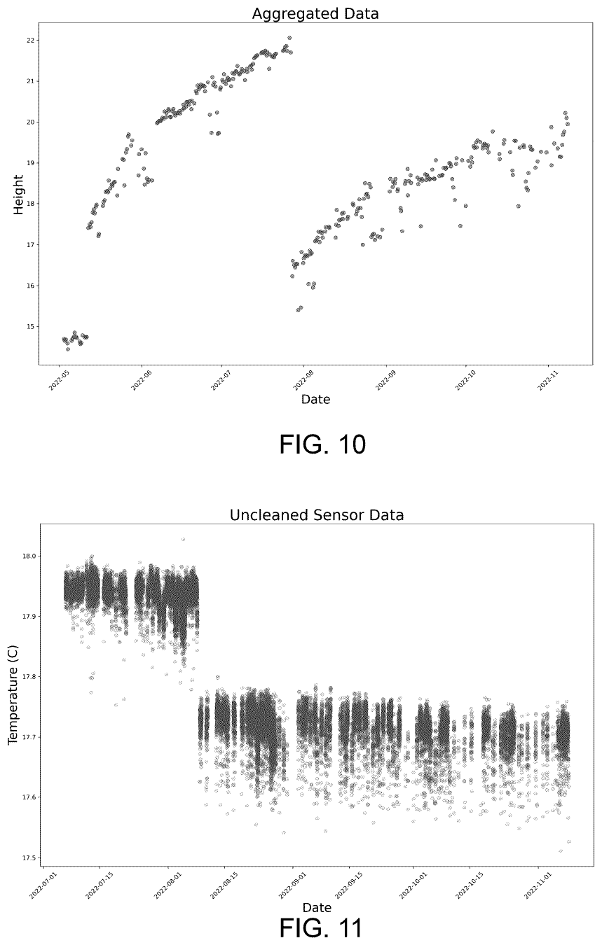

The next few figures provide a visual representation of the cleaning step. Referring back to FIG. 6 shows an example of uncleaned sensor data from a particular indicator. In FIG. 9, where the y-axis scale is changed, outliers have been removed. Finally, bootstrapping is performed and the aggregated data is shown in FIG. 10. It can be seen from FIG. 10 that the amount of variation has been significantly reduced and trends in the data are now visually apparent.

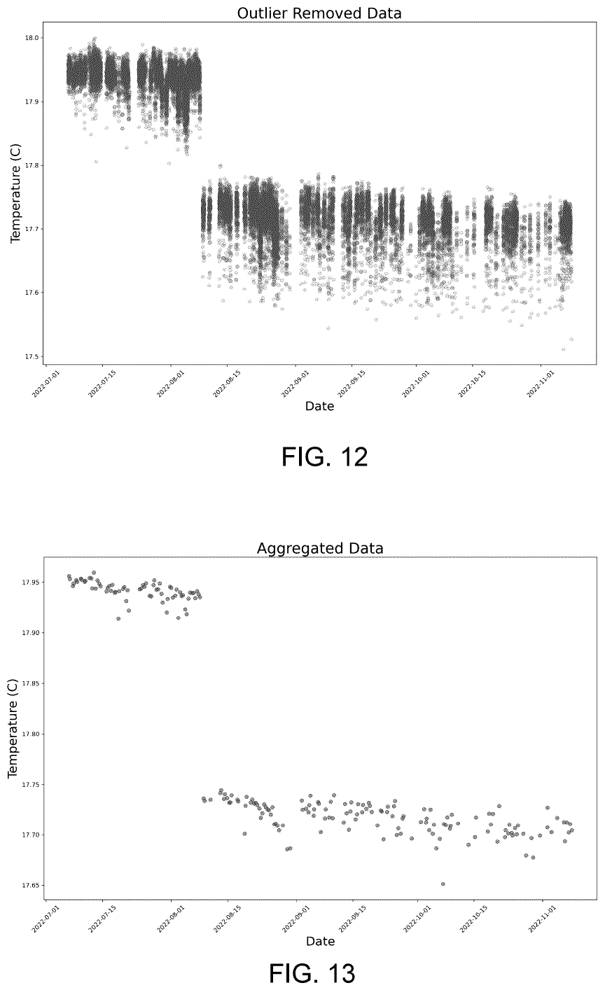

In another example, uncleaned sensor data from a different indicator is shown in FIG. 11 with lots of noise but not many outliers. After removing the outliers, shown in FIG. 12, there is not much difference. After bootstrapping, however, the aggregated data shown in FIG. 13 presents a much clearer picture of the data and its trends.

### Segmentation

In general, discernible trends are difficult to detect when the data exhibits significant shifts. Further, each shift may have a different pattern, and thus a general model cannot be created to handle all types of shifts. We describe two solutions that could be used in combination. First, a change-point detection solution seems appropriate given the significant shift due to PM activities relative to data noise. Second, a “rolling window” solution looks for data point variations over time, which we have found can be helpful in detecting trends near the beginning and the end of the dataset.

There are a number of commercially available segmentation algorithms, and in one embodiment, a change-point detection algorithm works by evaluating a data distribution of data points for a given segment of time. For example, ruptures <https://centre-borelli.github.io/ruptures-docs/> is a Python-based library package of coded solutions effective for the analysis and segmentation of non-stationary signals. See C. Truong, L. Oudre, N. Vayatis, Selective Review of Offline Change Point Detection Methods, Signal Processing, Vol. 167:107299 (2020). In one implementation, we focused on an unsupervised approach using a ruptures algorithm given that trends from PM activities may be drastically different than known shifts in the training set. In another embodiment, a semi-supervised multivariate approach narrows down the relevant inputs to a segmentation algorithm based on statistical significance compared to a target value.

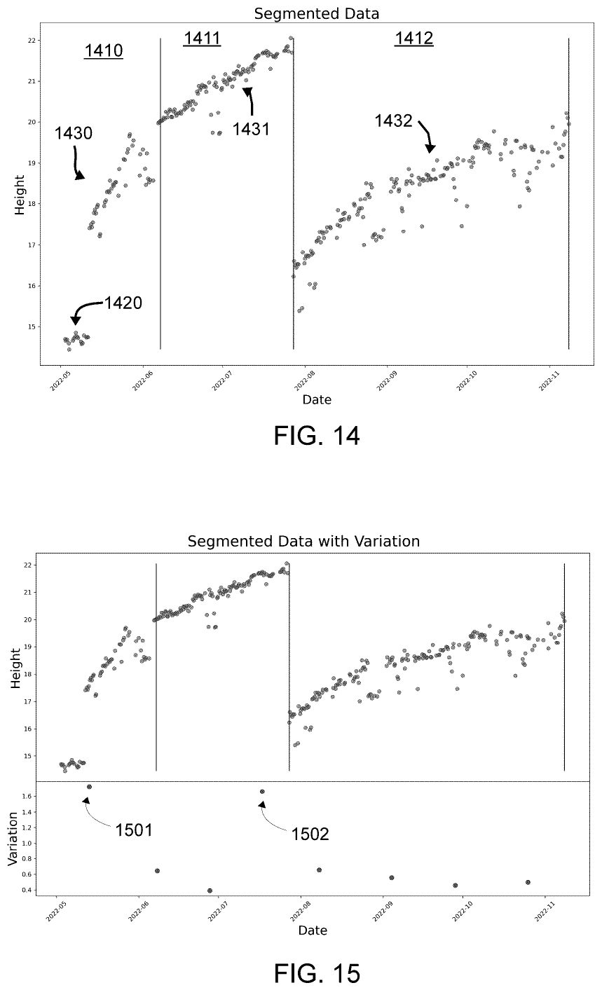

Referring back to the aggregated data shown in FIG. 10, a segmentation algorithm is applied with the result shown in FIG. 14. The segmentation algorithm captures some segments, including important segments like the middle segment 1411; but did not capture other segments, like the small cluster 1420 on the bottom left, and possibly another segment at the end, where the data runs out. In general, the segments 1410, 1411, 1412 seem logical; the trend of data group 1430 is upward, then a break in the data; the next data group 1431 trends upward at slightly lesser slope; after another sharp break, the third segment 1412 is quite a bit longer, having data group 1432 trending upward at lower height values.

A practical weakness of the rupture segmentation algorithm is that it requires a certain volume of data points in order to establish a distribution. This is likely the reason the algorithm missed that first low cluster 1420; and possibly a discrete cluster at the end, where it appears that a small number of points are starting to trend upward from group 1432—but not enough points are there to trigger creation of a separate segment.

A variation-based approach using a rolling window is shown in FIG. 15, with the variations indicated as discrete points below the segmented data plot of FIG. 14. A number of low variation points indicate not much break in the data; but the two high variation points 1501, 1502 indicate the large break in the data. In this case, the high points do not line up well with the segment lines because the granularity of the rolling point solution is not high—increased granularity would move those points closer to the line. Further, decreasing the size of the variation window would display more points.

Both approaches—a change-point algorithm and a rolling window—are directed to detecting segments. In combination, the change-point algorithm performs a basic detection of the segments, and the rolling window variation gives a confidence that the segments actually occur as detected.

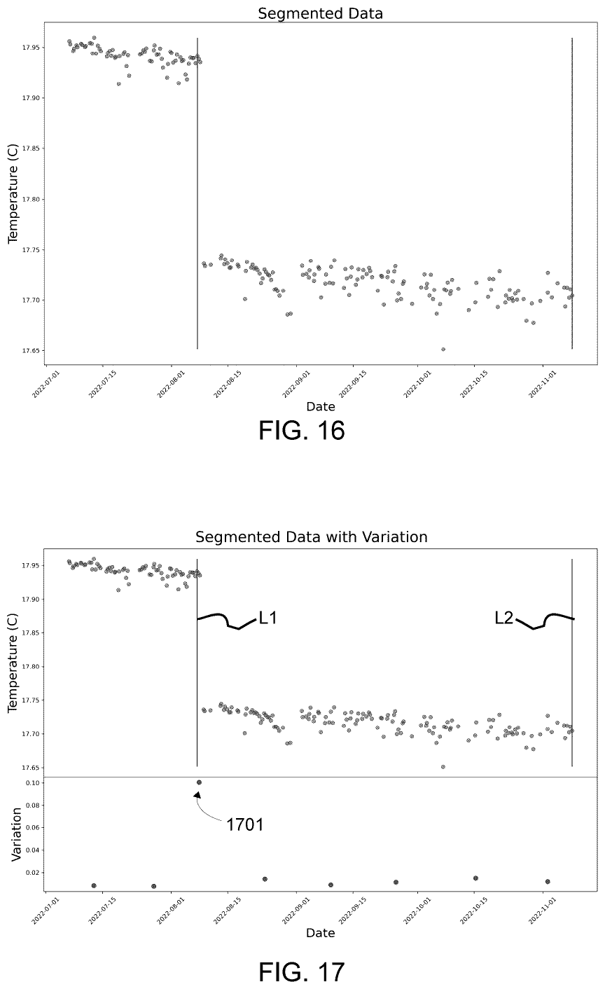

Alternatively, the segmentation decision could be based instead on the variation points shown by the rolling window approach. In another example, the segmentation algorithm is applied to the aggregated data shown in FIG. 13, with the result shown in FIG. 16. Applying the rolling window technique in FIG. 17 shows that the high variation point lines up well with segment line L1. In fact, the variation is generally a more exact indication of the break in the data because the change point algorithm is somewhat inexact, illustrated by letting a few points run over the segment line L2. Thus, the variation indicates more exactly where the segment(s) should occur. The fact that there is no high variation point proximate to segment line L2 indicates that the segmentation algorithm did not work well at the end of the data.

There are other known algorithms for performing segmentation, such as the changefinder algorithm. See https://pypi.org/project/changefinder/. In another example, regression can be used to determine whether a shift in the data occurs based on metrics such as variability from previous points and overall variability per segment. See https://ics.uci.edu/˜pazzani/Publications/survey.pdf.

### Statistical Modeling

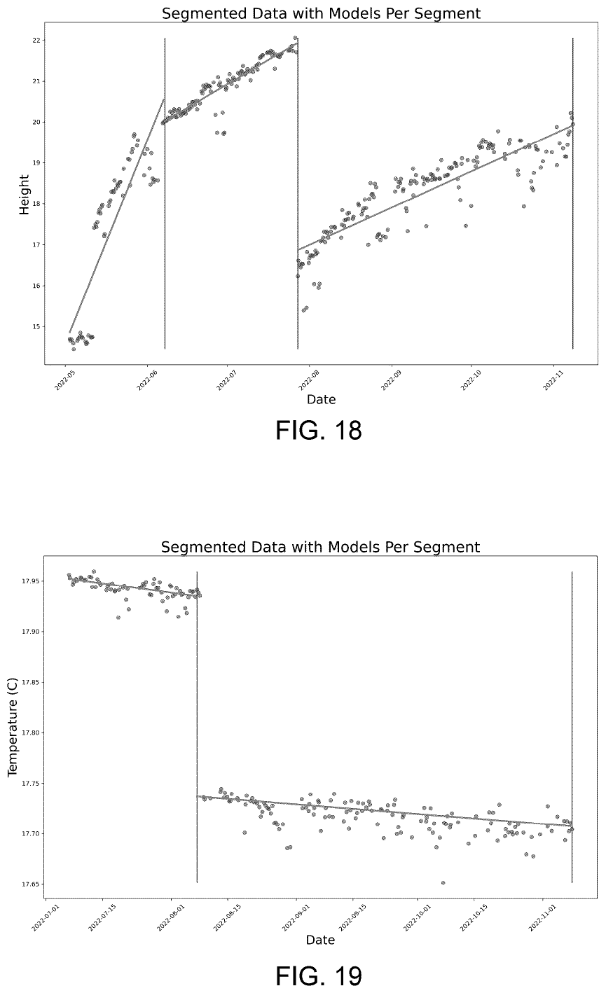

Once the segments have been identified, the trends are determined based on each segment. For example, using a standard linear fit statistical model, the slope and the intercept of the model can be compared to find differences across the segments. Once again referring back to the aggregated data shown in FIG. 10, a linear fit model is computed for each segment, as shown in FIG. 18. Then, the slope and intercept data is input to an anomaly detection algorithm which determines which slope(s) and intercept(s) are different than others. In this example, the larger slope value of the first segment transitioning to a smaller slope value in the second segment indicates a problem.

Another example is shown in FIG. 19, in which a linear fit is performed on the aggregated data shown in FIG. 16. In this example, the slopes are similar, but the intercepts are quite different. With only two segments, it is difficult to determine which is anomalous—that task is easier when there are more segments. Thus, sometimes the slope is the determining factor, sometimes it is the intercept, and sometime both in combination.

In some cases there is a non-linear relationship within segment(s), and therefore linear regression is not applicable to determine the shift in the data over time. In these cases, a variety of physics-based white box models could be used to determine trends per segment. A physics-based model is a model defined by an equation composed of variable(s), weight(s), and constant(s). A white box model is a model that is simple in structure (i.e. without many changing components). The combination of a physics-based model and a white box model results in a model similar to polynomial regression.

With regard to anomaly detection, there are known products and methods mostly utilizing univariate methods to detect outliers or failures. For example, using Part Averaging Testing (PAT), an upper and lower limit is chosen for each parameter of interest. Dies that are outside of these limits are considered fails. These limits can be fixed either statically for all wafers (SPAT) or dynamically for each wafer (DPAT) based on the mean and standard deviation of measured values. The PAT approach is best applicable if the measurements follow a Gaussian distribution. Further, output from these univariate methods could be provided as input to multivariate approaches. See M. Moreno-Lizaranzu and F. Cuesta, Sensors 2013, Vol. 13, 13521-13542.

Known multivariate techniques use mostly a principal component analysis (PCA) to transform the measurement parameters into a reduced set of new parameters with removed correlations, and the same univariate method can then be used to find outliers. However, PCA only removes the linear dependence between parameters. Full multivariate techniques are also known, such as One Class SVM, Isolation Forest, Local Outlier Factor, DBScan and Autoencoder, which are accepted methods in the machine learning community for outlier detection. These methods are also good for non-Gaussian distributions and can find outliers that are not seen in a univariate analysis, e.g. for dependent features that are not linear. See also Sendner et al., Combining Machine Learning with Advanced Outlier Detection to Improve Quality and Lower Cost, Advanced Processor Control Smart Manufacturing Conference (October 2020).

The creation and use of processor-based models for data analysis can be desktop-based, i.e., standalone, or part of a networked system—but given the heavy loads of information to be processed and displayed with some interactivity, processor capabilities (CPU, RAM, etc.) should be current state-of-the-art to maximize effectiveness. In the semiconductor foundry environment, the Exensio® analytics platform is a useful choice for building interactive GUI templates. In one embodiment, coding of the processing routines may be done using Spotfire® analytics software version 7.11 or above, which is compatible with Python object-oriented programming language, used primarily for coding machine language models.

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

1. A method for detecting anomalies resulting from maintenance activities on semiconductor equipment, comprising:
receiving a time-series dataset corresponding to at least one measured parameter of the semiconductor equipment;
cleaning the dataset;
segmenting the cleaned dataset;
statistical modeling of the segmented cleaned dataset; and
identifying anomalies in the dataset based on the statistical modeling of the segmented cleaned dataset.

2. The method of claim 1, further comprising taking corrective action to repair, replace or recalibrate the semiconductor equipment.

3. The method of claim 1, the dataset comprising at least one statistical indicator identified as useful in evaluating performance of the semiconductor equipment.

4. The method of claim 1, the cleaning step further comprising:
removing outliers from the dataset; and
reducing variation in the dataset.

5. The method of claim 4, the step of removing outliers further comprising, for each of a plurality of data points in the dataset:
determine a linear fit around the data point;
calculate the mean value of the linear fit;
calculate the difference between the mean value of the linear fit and the data point; and
remove the data point from the dataset if the difference exceeds a threshold.

6. The method of claim 5, further comprising replacing the removed data point in the dataset with the mean value.

7. The method of claim 4, the step of removing outliers further comprising, for each of a plurality of data points in the dataset:
define a neighborhood of points adjacent to the data point;
calculate the mean value of the neighborhood of points;
evaluate the difference between the mean value of the neighborhood of points and the data point; and
remove the data point from the dataset if the evaluation of the difference indicates that the data point is anomalous.

8. The method of claim 4, the step of reducing variation further comprising bootstrapping the dataset to approximate a distribution of the dataset.

9. The method of claim 1, the segmentation step further comprising evaluating a distribution of data points in the dataset for a plurality of segments of time.

10. The method of claim 9, the segmentation step implemented using a change-point detection algorithm.

11. The method of claim 1, the segmentation step further comprising evaluating how a distribution of data points in the dataset varies over time.

12. The method of claim 1, further comprising;
for each segment identified in the segmentation step, determine a linear fit for a plurality of data points in the segment;
determine a slope and an intercept corresponding to each linear fit; and
evaluate differences in the determined slopes and intercepts.

13. A method for detecting anomalies resulting from maintenance activities on semiconductor equipment, comprising:
receiving a time-series dataset having a plurality of data points corresponding to at least one measured parameter of the semiconductor equipment;
reducing noise in the dataset;
identifying a plurality of segments in the dataset on the basis of a plurality of discernable shifts in the data points;
determining from the plurality of segments trends in the data points based on the segments; and
determining whether the trends in the data points are expected or anomalous.

14. The method of claim 13, the step of determining whether the trends in the data points are expected or anomalous is implemented in a change-point detection algorithm.

15. The method of claim 13, the step of determining whether the trends in the data points are expected or anomalous is implemented in a rolling window detection algorithm.

16. The method of claim 13, further comprising:
removing outliers from the dataset; and
reducing variation in the dataset.

17. The method of claim 16, the step of removing outliers further comprising, for each of a plurality of data points in the dataset:
defining a neighborhood of points adjacent to the data point;
calculating the mean value of the neighborhood of points;
evaluating the difference between the mean value of the neighborhood of points and the data point; and
removing the data point from the dataset if the evaluation of the difference indicates that the data point is anomalous.
